(19) United States
(12) Patent Application Publication
(10) Pub. No.: US 2006/0082639 A1
(43) Pub. Date: Apr. 20, 2006

(54) Light scanning unit

(75) Inventor: Takahiro Kojima, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/253,760

(22) Filed: Oct. 20, 2005

(30) Foreign Application Priority Data
Oct. 20, 2004 (JP) 2004-305806
Mar. 9, 2005 (JP) 2005-065487

(51) Int. Cl. B41J 2/435

(52) U.S. Cl. 347/224

(57) ABSTRACT

A light scanning unit according to the present invention has a polygon motor that scans a laser beam emitted from a laser source, a plate that supports the polygon motor, and a cover that is fixed to the plate and covers the polygon motor. The polygon motor, plate, and cover constitute a motor block. The motor block is housed in a housing. The housing is made of synthetic resin. The plate and cover are made of metal. When a polygon mirror is attached to a circuit board and the base end of a motor shaft is inserted into a fix hole of the plate, the entire surface of the circuit board directly comes into contact with the plate surface.

### CROSS-REFERENCE TO RELATED APPLICATION

This application is based upon and claims the benefit of priority from the prior Japanese Patent Application No. 2004-305806, filed on Oct. 20, 2004, and Japanese Patent Application No. 2005-065487, filed on Mar. 9, 2005, the entire contents of which are incorporated herein by reference.

### BACKGROUND OF THE INVENTION

1. Field of the Invention

The present invention relates to a light scanning unit incorporated in an image forming apparatus that adopts an electrophotographic system for use in a fax machine or printer.

2. Description of the Related Art

Some image forming apparatuses such as a fax machine or a printer adopt an electrophotographic system. In such an image forming apparatus, a charger, an exposure unit, a development unit, and a transfer unit are disposed around a photoconductor drum. The surface of the photoconductor drum is exposed by the charger while the photoconductor drum is being rotated to form an electrostatic latent image, and the development unit is used to develop the electrostatic latent image to thereby form a toner image on the surface of the photoconductor drum. After that, the transfer unit is used to transfer the toner image on the surface of the photoconductor drum onto a recording paper. Finally, the toner image on the recording paper is fixed by a fixing unit.

The exposure unit has: a laser source; a polygon mirror that deflects a laser beam emitted from the laser source to perform scanning operation; a polygon motor that rotates the polygon mirror; and an optical system that focuses the laser beam deflected by the polygon mirror onto the photoconductor drum. The exposure unit is contained within a housing of the image forming apparatus.

A laser light that has been modulated by an electrical signal is emitted from the laser source and reflected by the polygon mirror. The reflected laser beams is converged and focused, by an optical lens, onto the photoconductor drum. Further, when the polygon mirror is rotated by the polygon motor, the laser beam is deflected by the polygon mirror and scans the surface of the photoconductor drum to thereby forming an electrostatic latent image on the surface of the photoconductor drum.

Jpn. Pat. Appln. Laid-Open Publication No. 2002-108152 discloses an example of the image forming apparatus having an exposure unit. In the exposure unit disclosed in this publication, a polygon motor is directly fixed to a housing, so that a problem related to vibration of the polygon motor occurs. In particular, when a large-sized polygon motor is adopted, or when the rotation speed of the polygon motor is high, the vibration becomes larger and the housing vibrates sympathetically to generate noise, or misalignment in scanning direction is caused.

Further, Jpn. Pat. Appln. Laid-Open Publication No. 2000-111825 discloses a scanning optical apparatus that can cope with this problem. In this apparatus, in order to suppress the vibration of an optical box due to the rotation of a polygon mirror, a motor base plate is threadably fixed to the optical box and the optical box is fixed to an optical bench. This reduces the vibration of the motor to thereby prevent the vibration from being propagated to the optical box.

However, in this scanning optical apparatus, there is a space between the motor base plate and the optical box to which the motor base plate is attached. Therefore, when the motor is rotated, the motor base plate is vibrated to generate noise, so that further improvement has been required.

### BRIEF DESCRIPTION OF THE DRAWINGS

FIG. 1 is a view schematically showing a configuration of an image forming apparatus incorporating a light scanning unit according to an embodiment of the present invention;

FIG. 2 is an exploded perspective view showing a motor block of the light scanning unit according to the embodiment of the present invention;

FIG. 3 is a perspective view showing an assembled state of the motor block according to the embodiment of the present invention;

FIG. 4 is a view showing a configuration of an optical system in the light scanning unit according to the embodiment of the present invention;

FIG. 5 is an exploded perspective view showing a state in which the motor block of the light scanning unit according to the embodiment of the present invention is to be fixed to a housing;

FIG. 6 is a perspective view showing a state in which the motor block of the light scanning unit according to the embodiment of the present invention has been fixed to the housing, as viewed from a different direction;

FIG. 7 is a perspective view showing a state in which a roof plate has been fitted to the housing of the light scanning unit according to the embodiment of the present invention;

FIG. 8 is a bottom view showing the housing of the light scanning unit according to the embodiment of the present invention, as viewed from below;

FIG. 9 is an exploded perspective view showing a motor block of a light scanning unit according to a second embodiment of the present invention;

FIG. 10 is a perspective view showing an assembled state of the motor block of the light scanning unit according to the second embodiment of the present invention;

FIG. 11 is an exploded perspective view showing a state in which the motor block of the light scanning unit according to the second embodiment of the present invention is to be fixed to a housing;

FIG. 12 is a cross-sectional view showing the motor block of the light scanning unit according to the second embodiment of the present invention; and

FIG. 13 is a characteristic graph showing a noise spectrum of the light scanning unit according to the second embodiment of the present invention.

### DETAILED DESCRIPTION OF THE INVENTION

Throughout this description, the embodiments and examples shown should be considered as exemplars, rather than limitations on the apparatus of the present invention.

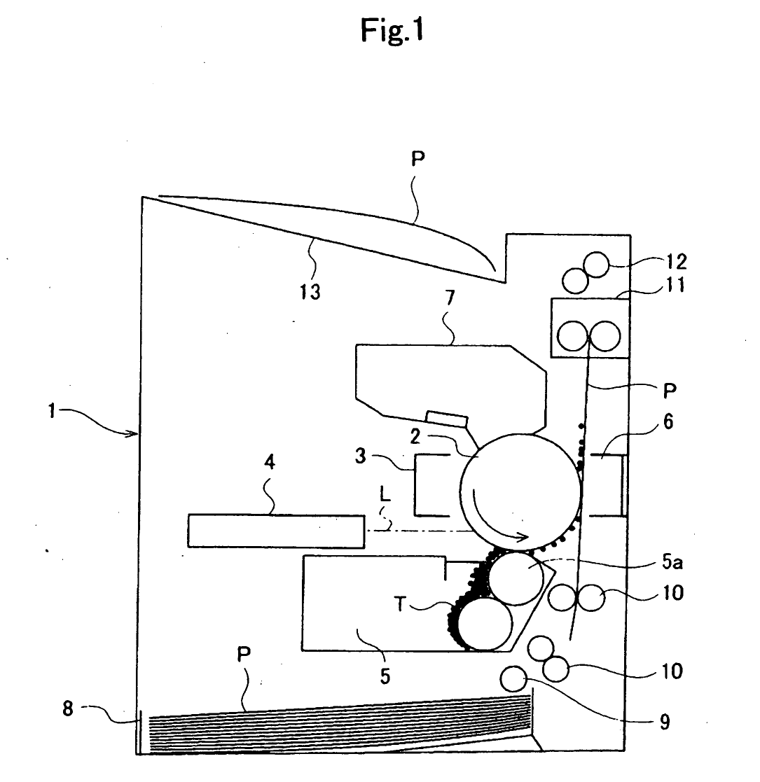

FIG. 1 is a view schematically showing a configuration of an image forming apparatus incorporating a light scanning unit according to an embodiment of the present invention. Firstly, with reference to FIG. 1, the entire configuration of an image forming apparatus using a light scanning unit according to the present invention will be described.

FIG. 1 shows an image forming apparatus that feeds a recording paper P from the lower side to upper side of the drawing to print an image on the recording paper P. As a developer, a magnetic toner is used. Reference numeral 1 is the main body of an image forming apparatus, and numeral 2 is a photoconductor drum. The photoconductor drum 2 is rotated, by a rotation drive unit(not shown), in the direction denoted by the arrow in the drawing. Around the photoconductor drum 2, a charger 3, a light scanning unit 4, a development unit 5, a transfer unit 6, and a cleaning unit 7 are disposed.

The charger 3 adopts a corona charging system and charges the surface of the rotating photoconductor drum 2. The light scanning unit 4 irradiates the surface of the photoconductor drum 2 with a laser beam L to expose it to thereby form an electrostatic latent image. The development unit 5 uses a development roller 5a to supply the surface of the photoconductor drum 2 with a magnetic toner T to develop the electrostatic latent image to thereby form a toner image. The transfer unit 6 transfers the toner image formed on the surface of the photoconductor 2 onto the recording paper P. The cleaning unit 7 removes the magnetic toner remaining on the surface of the photoconductor drum 2 after completion of the image transfer process.

Reference numeral 8 is a paper supply cassette which is disposed below the developing unit 5, and numeral 9 is a take-out roller that takes out, one by one, the recording papers P stacked on the paper supply cassette 8. Reference numeral 10 is a feeding roller that feeds upwardly the recording paper P that has been taken out from the paper supply cassette 8 to the portion between the photoconductor drum 2 and transfer unit 6. Reference numeral 11 is a fixing unit which is disposed above the portion between the photoconductor drum 2 and transfer unit 6. The fixing unit 11 fixes the toner image onto the recording paper P onto which the toner image has been transferred while being passed through between the photoconductor drum 2 and transfer unit 6. Reference numeral 12 is a paper discharge roller that discharges the recording paper P that has been passed through the fixing unit 11 to a paper discharge tray 13 provided in the upper surface portion of the apparatus main body 1.

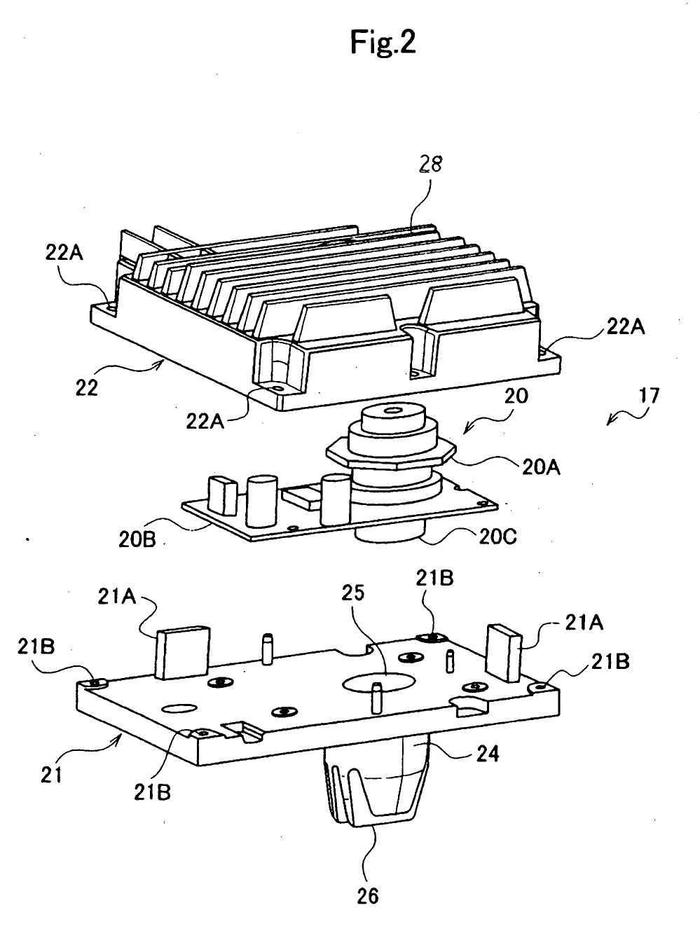

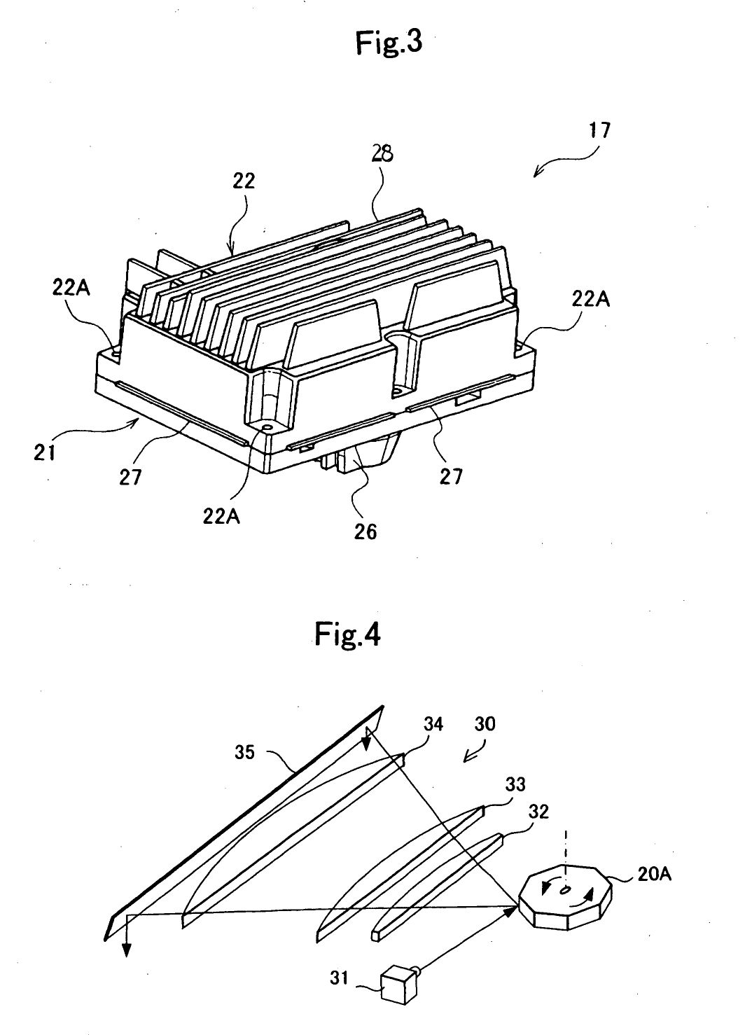

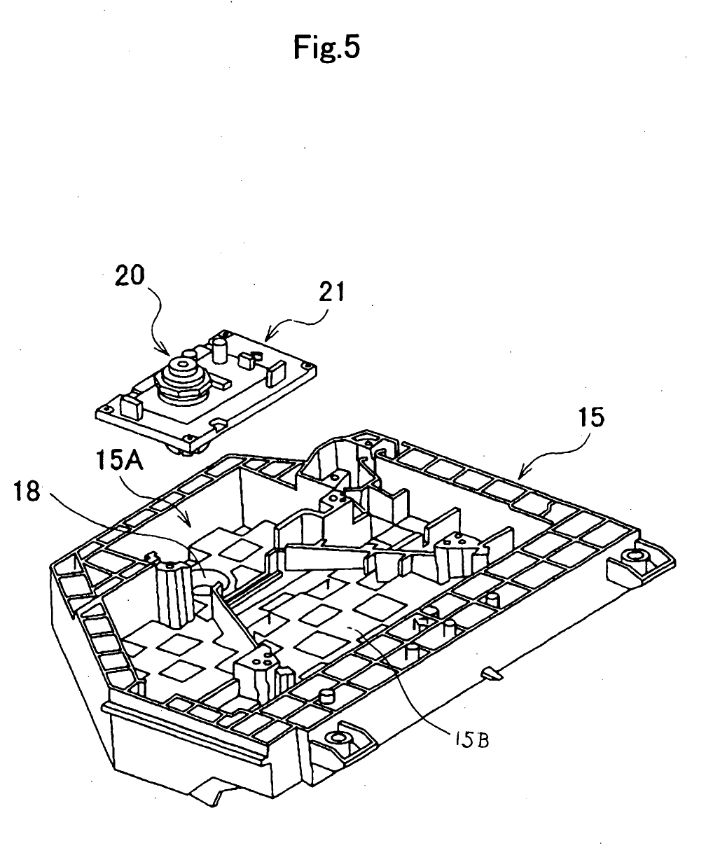

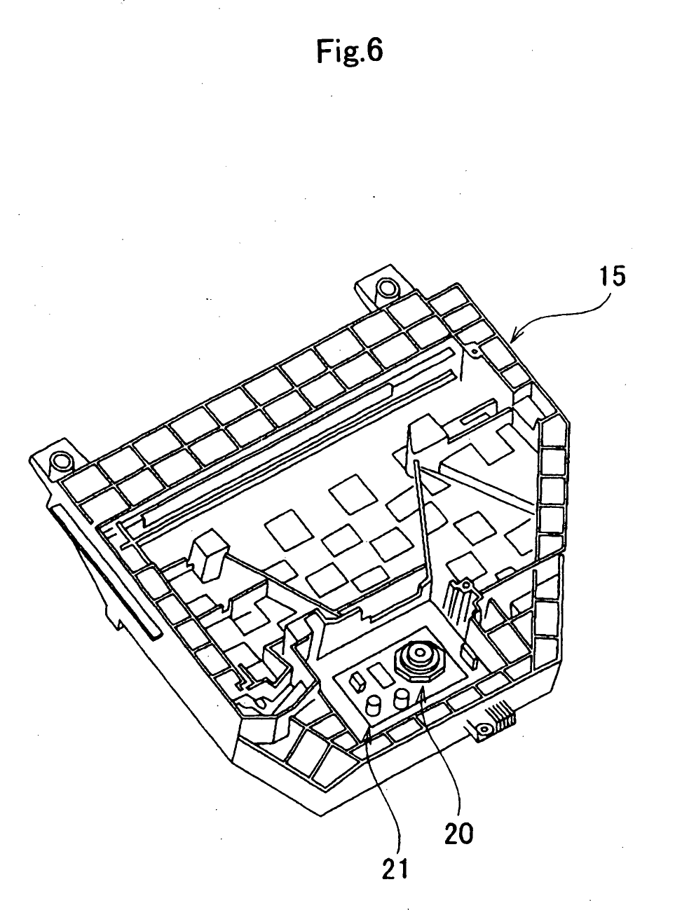

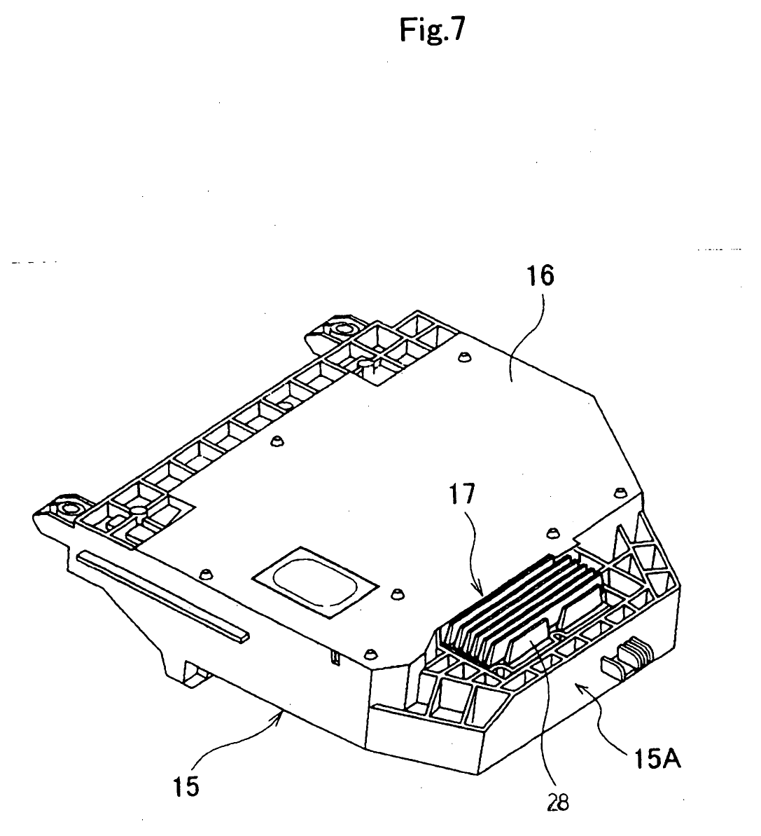

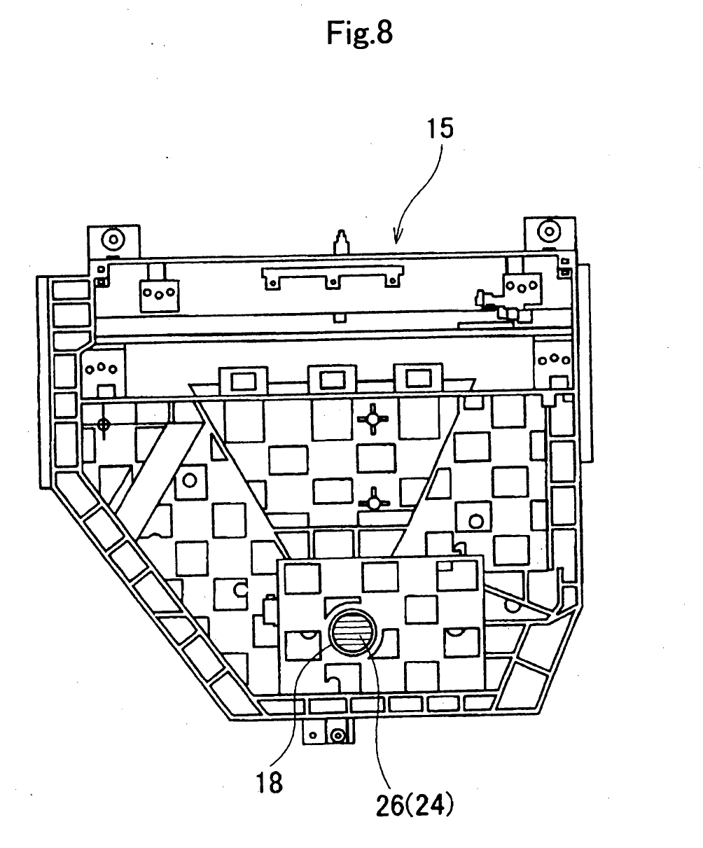

The light scanning unit 4 incorporated in the image forming apparatus will next be described. FIG. 2 is an exploded perspective view showing a motor block of the light scanning unit, FIG. 3 is a perspective view showing an assembled state of the motor block, FIG. 4 is a view showing a configuration of an optical system in the light scanning unit, FIG. 5 is an exploded perspective view showing the motor block and a housing, FIG. 6 is a perspective view showing a state in which the plate of the motor block has been fixed to the housing, FIG. 7 is a perspective view showing a state in which a roof plate has been attached to the housing, and FIG. 8 is a bottom view showing the housing as viewed from below.

The light scanning unit 4 is mainly constituted by a housing 15, a roof plate 16, and a motor block 17. Firstly, a configuration of the motor block 17 will be described with reference to FIGS. 2 and 3.

The motor block 17 is constituted by a polygon motor 20, a plate 21 that supports the polygon mirror 20, and a cover 22 that is fixed to the plate 21 and covers the polygon motor 20.

The polygon motor 20 is provided with a polygon mirror 20A and rotates the polygon mirror 20A at high speed to allow a laser beam that has been emitted from a laser source to scan in the main scanning direction. The polygon motor 20 is further provided with a circuit board 20B and motor shaft 20C.

The circuit board 20B is a plate material on which a control circuit that controls the polygon motor 20 is mounted. The motor shaft 20C, which is a main component of the polygon motor 20, includes a rotary shaft (not shown) inside thereof. The polygon mirror 20A is fitted to the rotary shaft. The circuit board 20B is fitted to the intermediate position of the motor shaft 20C. The base end (lower end in FIG. 2) of the motor shaft 20C extends downward from the circuit board 20B.

The plate 21 is a plate material for supporting the polygon motor 20. The plate 21 is in the form of a rectangular plane plate. Two vertical plates 21A for positioning of the circuit board 20B are provided on the upper surface of the plate 21. Further, a cylindrical portion 24 for fixing the base end of the motor shaft 20C is provided on the lower surface of the plate 21.

The cylindrical portion 24 is integrally formed with the plate 21. The cylindrical portion 24 has, on the upper surface of the plate 21, a fix hole 25 into which the motor shaft 20C is inserted. The inner diameter of the fix hole 25 is substantially the same as the outer diameter of the base end of the motor shaft 20C. The base end of the motor shaft 20C is fitted in the fix hole 25 and tightly inserted thereinto, and thereby the position of the motor shaft 20C is fixed. A radiation fin 26 is provided at the leading end (lower end) of the cylindrical portion 24. The radiation fin 26 is a member for radiating heat generated in the polygon motor 20 to the outside.

The plate 21 is made of metal such as aluminium. Since aluminum has high heat conductivity, heat is easily transmitted to the radiation fin 26 of the cylindrical portion 24, increasing heat radiation efficiency. Further, when the plate 21 is made of metal such as aluminium, it is possible to support the polygon motor 20 more firmly and to suppress transmission of vibration, thereby increasing noise reduction effect. Furthermore, it is possible to prevent the plate 21 from being deformed and melted by the heat emitted from the polygon motor 20.

Screw holes 21B for fixing the cover 22 to the plate 21 are provided on the four corners of the plate 21. Like the plate 21, the cover 22 is made of metal such as aluminium. The cover 22 has a role of preventing noise directly generated from the polygon motor 20 from escaping to the outside.

The cover 22 covers the entire polygon motor 20. The cover 22 has a shape like a square dish turned upside down. Screw holes 22A for fixing the cover 22 to the plate 21 by screws (not shown) are provided at the four corners of the cover 22. Further, a radiation fin 28 is provided at the upper surface of the cover 22. The radiation fin 28 is a member for radiating heat generated in the polygon motor 20 to the outside.

FIG. 3 shows a state where the polygon motor 20, plate 21, and cover 22 have been assembled. The cover 22 is attached to the plate 21 through seals 27 and fixed by four screws (not shown).

FIG. 4 is a view conceptually showing the optical system of the light scanning unit. In FIG. 4, reference numeral 30 is an optical system having the polygon mirror 20A at the center thereof. The polygon mirror 20A is rotated in the counterclockwise direction. A laser beam is projected from a laser source 31 onto the polygon mirror 20A, and reflected by it. The reflected laser beam is then passed through a first fθ lens 32 and second fθ lens 33 and the scanning speed of the laser beam is corrected. After that, the laser beam is passed through an image forming lens 34 and emitted therefrom.

The emitted laser beam is folded by a reflection mirror 35 and guided to the photoconductor drum 2. After that, the laser beam scans the photoconductor drum 2 while the beam is being deflected. Diagramatic representation of an optical path up to the photoconductor drum 2 is omitted here. Further, a beam detector (BD sensor) for detecting the start of the deflection scan of the laser beam reflected by the polygon mirror 20A is provided in the optical system. Diagramatic representation of this is also omitted here.

A relationship between the housing 15 and motor block 17 will next be described with reference to FIGS. 5 to 8. For the shake of simplicity, the cover 22 is not shown in FIGS. 5 to 8.

The housing 15 is formed in a dish-like shape as a whole. A housing portion 15A in which the motor block 17 is fitted is formed at one end (lower end in FIG. 8) of the housing 15. An insertion hole 18 into which the cylindrical portion 24 of the motor block 17 is inserted is formed in the housing portion 15A. Further, provided at the other end (upper end in FIG. 8) of the housing 15 is a fan-shaped space 15B, in which the lenses of the optical system shown in FIG. 4 are disposed.

The entire housing 15 is formed from synthetic resin. The synthetic resin used here is mixture of polycarbonate and ABS resin. Further, a reinforcement rib is provided around the housing 15.

FIG. 5 shows a state before the motor block 17 is fitted in the housing 15, and FIG. 6 shows a state where the motor block 17 has been fitted in the housing portion 15A of the housing 15 as viewed from a different direction from that of FIG. 5.

In a state where the motor block 17 has been fitted in the housing 15, the cylindrical portion 24 including the radiation fin 26 has been inserted into the insertion hole 18 in a non-contact manner. The leading end of the cylindrical portion 24 is extended outside of the housing 15. Heat generated in the polygon motor 20 is transmitted to the radiation fin 26 protruding from the housing 15 through the cylindrical portion 24 and discharged to the outside.

A space is provided between the insertion hole 18 and the cylindrical portion 24 including the radiation fin 26 so that the cylindrical portion 24 does not contact the housing 15 when being inserted into the insertion hole 18. That is, as shown in FIG. 8, the diameter of the cylindrical portion 24 including the radiation fin 26 is smaller than that of the insertion hole 18 of the housing 15, thereby preventing the contact between them. The reason for this configuration is to prevent the vibration generated in the polygon motor 20 from directly being transmitted to the housing 15.

FIG. 7 shows a state where the motor block 17 has been fitted in the housing 15 and the housing 15 has been covered by the roof plate 16. As shown in FIG. 7, the motor block 17 is not covered by the roof plate 16, but protruded toward the outside. Further, in this state, the diameter and shape of the respective components are set so that the cover 22 and radiation fin 28 do not contact the housing 15 and roof plate 16.

On one side surface (hidden left deep side in FIG. 3) of the cover 22, an opening (not shown) is formed. A laser beam from the optical system (laser source 31 shown in FIG. 4), which has not been deflected, enters the opening, and the laser beam that has been deflected by the polygon mirror 20A is emitted from the opening. Although the components of the optical system before deflection are disposed outside the motor block 17, they may be disposed inside the motor block 17. The present invention is applicable to either case.

As shown in FIG. 7, the roof plate 16 covers the housing 15 in a state where the motor block 17 and the like have been incorporated in the housing 15. The roof plate 16 has a shape that does not cover the entire housing 15, that is, does not cover the motor block housing portion 15A, allowing the radiation fin 28 of the motor block 17 to be protruded toward the outside.

The entire roof plate 16 is formed from synthetic resin. The synthetic resin used for the roof plate 16 is mixture of polycarbonate and ABS resin, as in the case of the housing 15. The roof plate 16 may be formed from a steel plate such as SECC (electrogalvanized steel).

The light scanning unit of the present invention has the configuration described above. The polygon motor 20 is rotated at high speed along with the operation of the image forming apparatus to scan a laser beam, which vibrates the polygon motor 20 and generates heat from the polygon motor 20, laser source, and the like.

However, the motor shaft 20C is firmly fixed in the fix hole 25, and the circuit board 20B is tightly attached to-and supported by the metal plate 21, so that it is possible to sufficiently suppress the vibration of the polygon motor 20.

Further, the natural vibration frequency of the plate 21 and cover 22 is far higher than that of the housing 15 made of synthetic resin, so that resonance between the vibration of the plate 21 and that of housing 15 hardly occurs.

Further, the cylindrical portion 24 is inserted into the insertion hole 18 of the housing 15 in a non-contact manner, that is, the cylindrical portion 24 does not contact the housing 15, so that the vibration of the cylindrical portion 24 is not directly transmitted to the housing 15. Further, it is possible to significantly reduce the vibration level of the housing 15, even if the vibration is transmitted from the plate 21 thereto.

Thus, the vibration to be transmitted from the polygon motor 20 to the housing 15 is reduced to significantly reduce noise caused by the vibration of the housing 15. Further, the noise generated by the polygon motor 20 itself hardly escapes from the space surrounded by the metal plate 21 and cover 22 to the outside. As a result, it is possible to significantly reduce the noise generated by the polygon motor 20.

That is, the cover 22 and plate 21 cover the polygon motor 20 in an integrated manner, and the plate 21 is made of metal such as aluminium. This reduces the transmission of the vibration whose frequency easily vibrates the housing 15 to increase noise reduction efficiency.

The heat generated in the polygon motor 20 and the like is transmitted to the plate 21 and cylindrical portion 24. However, this heat is transmitted to the radiation fin 26 extended outside of the housing 15 and discharged outside. Further, the heat transmitted to the cover 22 is transmitted to the radiation fin 28 situated outside of the housing 15 and discharged outside. The polygon motor 20 is thus effectively cooled to reliably prevent temperature rise resulting from the heat staying within the housing 15.

The cover 22 is used to cover the polygon motor 20 in the above embodiment. However, since it is only necessary to suppress the vibration of the polygon motor 20 in the case where the noise generated directly from the polygon motor 20 is small, attachment of the cover 22 may be omitted.

Further, although the seals 27 are provided between the plate 21 and cover 22 in the above embodiment, the cover 22 may directly be attached to the plate 21 without providing the seals 27. Alternatively, a cushioning material that absorbs the vibration generated in the polygon motor 20 may be provided between the plate 21 and cover 22. A thick elastic plate is used as the cushioning material. In this case, the plate 21 and cover 22 are not directly fixed to each other, but they are individually fixed to the elastic plate and the cover 22 is supported by the elastic plate.

With this configuration, the vibration transmitted from the polygon motor 20 to the plate 21 can be absorbed by allowing the elastic deformation of the elastic plate to convert the vibration into heat. That is, the cover 22 having a reasonable weight serves as a load, which allows the elastic plate to elastically be deformed to convert vibration energy into heat energy to thereby absorb the vibration of the plate 21. As a result, the vibration of the plate 21 can be reduced to reduce the vibration of the housing 15.

The plate 21 is formed into a plate-like shape and the cover 22 is formed into a dish-like shape. Alternatively, however, the plate 21 may be formed into a dish-like shape and the cover 22 is formed into a plate-like shape.

A second embodiment of the present invention will be described below.

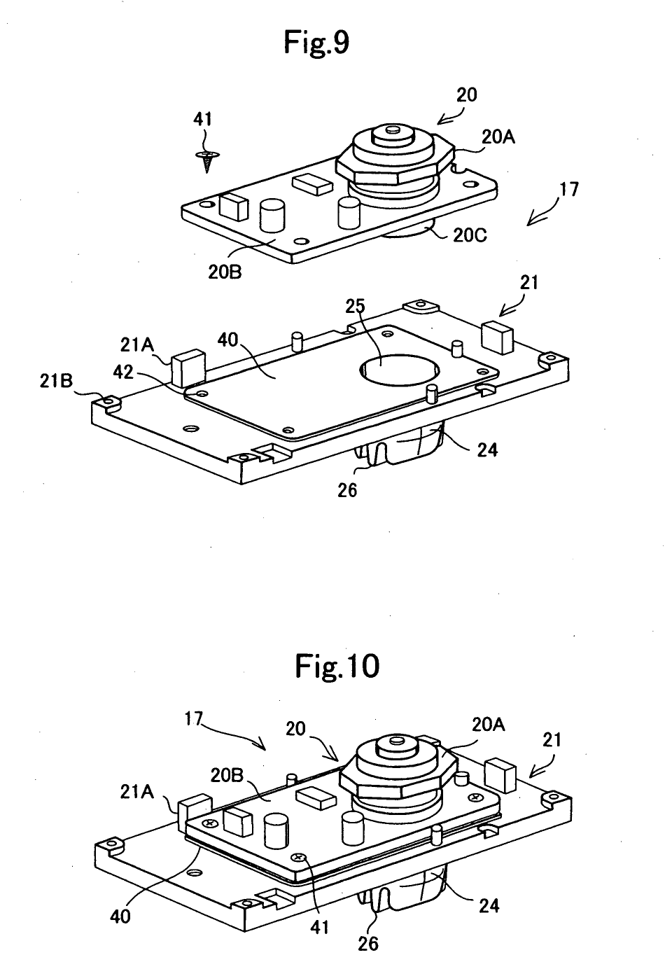

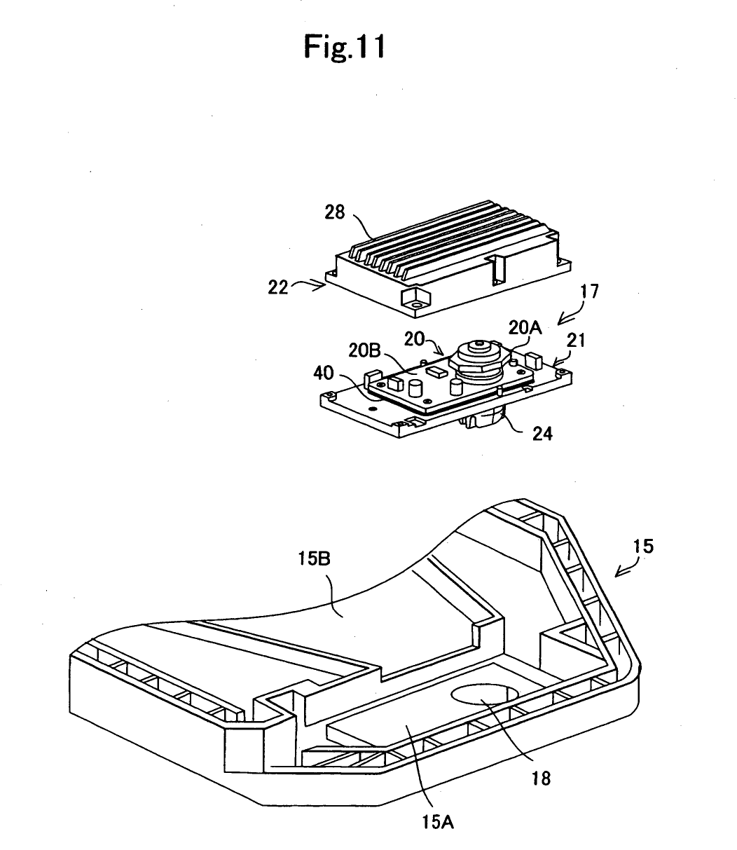

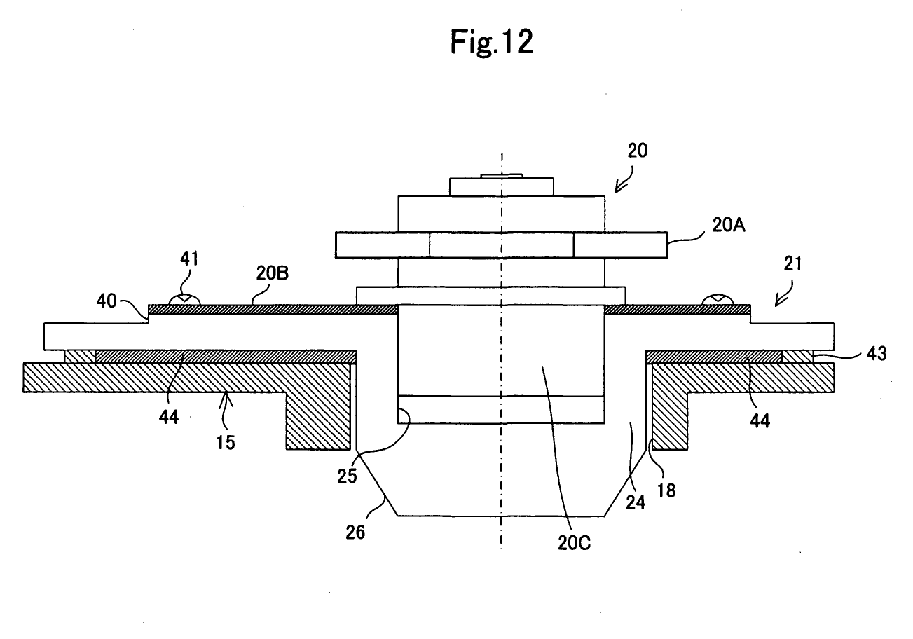

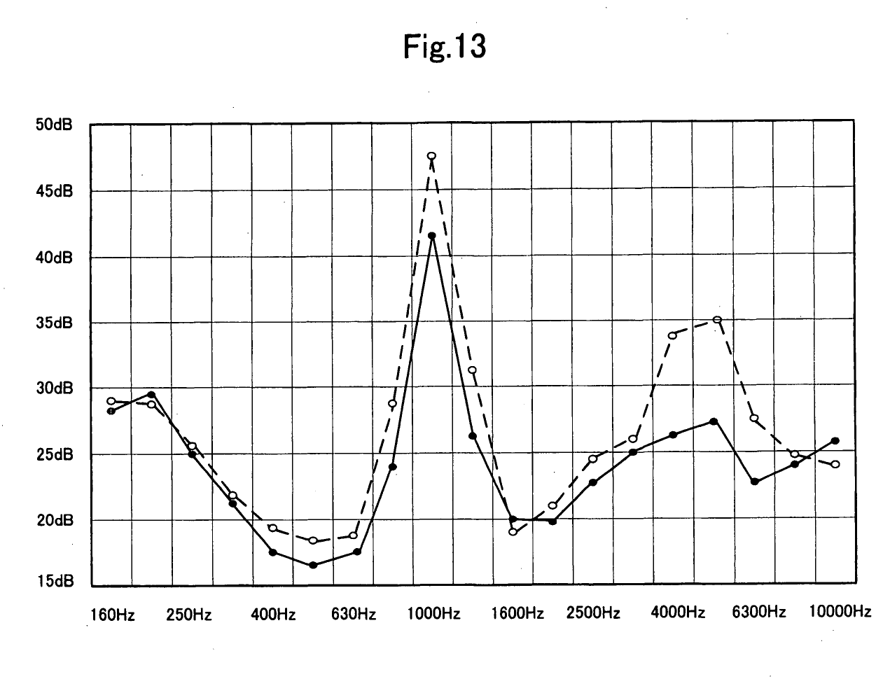

FIG. 9 is an exploded perspective view showing the configuration of a motor block of a light scanning unit according to a second embodiment, FIG. 10 is a perspective view showing an assembled state of the motor block, FIG. 11 is an exploded perspective view showing a state in which the motor block is to be fixed to a housing, and FIG. 12 is a cross-sectional view showing an assembled state of the motor block. Further, FIG. 13 is a characteristic graph showing a noise spectrum of the light scanning unit according to the second embodiment.

A motor block 17 shown in FIG. 9 is constituted by a polygon motor 20 and a plate 21. The polygon motor 20 has a polygon mirror 20A and a motor shaft 20C. A circuit board 20B is attached to the polygon motor 20. The circuit board 20B includes a circuit for controlling drive of the polygon motor 20.

The base end (lower end) of the motor shaft 20C extends downward from the circuit board 20B. That is, the polygon mirror 20A is disposed above the upper surface of the circuit board 20B, and the base end of the motor shaft 20C is protruded from the lower surface of the circuit board 20B.

The plate 21, which has a plate-like shape, supports the polygon motor 20 and is made of a metal plate having high heat conductivity, such as aluminium die cast. A cylindrical portion 24 for fixing the base end of the motor shaft 20C is provided on the lower surface of the plate 21 in such a manner to be extended downward. The cylindrical portion 24 has a fix hole 25 extended downward from the upper surface of the plate 21, into which the motor shaft 20C is inserted. Further, a radiation fin 26 is provided on the outer circumference of the cylindrical portion 24. The radiation fin 26 radiates heat generated inside to the outside.

Further, a thick base 40 is provided on the upper surface of the plate 21. The base 40 directly contacts the circuit board 20B so as to support it. Vertical plates 21A for positioning the circuit board 20B at the time of fixing are provided around the base 40.

As shown in FIG. 10, the polygon motor 20 is placed on the plate 21 and fixed thereto. At this time, the circuit board 20B is firmly fixed to the base 40 by screws in a surface contact state. Screw holes 42 in which screws 41 are screwed are provided on the base 40. The cover 22 shown in FIGS. 2 and 4 may be used to cover the motor block 17. In this case, the cover 22 is fixed to the frame 21.

FIG. 11 shows a state where the polygon motor 20, plate 21, and cover 22 are to be housed in the housing 15. The housing 15, which has the same configuration as that shown in FIGS. 5 and 6, includes a housing portion 15A that houses the motor block 17 constituted by the polygon motor 20, plate 21, and cover 22, and a fan-shaped space 15B, in which the lenses of the optical system 30 are disposed. The housing has a dish-like shape as a whole and is molded by synthetic resin. The synthetic resin used here is mixture of polycarbonate and ABS resin.

A through hole 18 is provided in the housing portion 15A for the motor block. The cylindrical portion 24 formed on the plate 21, including the radiation fin 26, is inserted into the through hole 18. The diameter of the through hole 18 is set such that the cylindrical portion 24 and the housing 15 do not contact each other. The reason for this is to prevent the vibration of the polygon motor 20 from being directly transmitted to the housing 15. Further, a housing portion 15B (not shown) that houses the optical system is covered by a roof plate 16, as in the case shown in FIG. 7.

FIG. 12 is a partly cross-sectional view showing a state where the polygon motor 20 and plate 21 are fitted in the housing 15. As shown in FIG. 12, the base end of the motor shaft 20C of the polygon motor 20 is inserted into the fix hole 25 of the plate 21, and the circuit board 20B is fixed to the base 40 of the plate 21 by screws 41 in a surface contact state. The plate 21 to which the polygon motor 20 has been fixed is then fitted in the housing portion 15A of the housing 15. The cylindrical portion 24 and radiation fin 26 of the plate 21 that have been inserted into the insertion hole 18 are extended outside of the housing 15.

Therefore, it is possible to discharge the heat generated in the plate 21 through the radiation fin 26. Further, since the inner diameters of the cylindrical portion 24 and radiation fin 26 are smaller than that of the insertion hole 18, the cylindrical portion 24 and radiation fin 26 do not contact the housing 15, preventing the vibration of the polygon motor 20 from being directly transmitted to the housing 15.

The plate 21 is fixed on support pedestals 43 formed on the upper surface the housing 15, and foamed rubber 44 is adhered to the bottom surface of the plate 21, thereby filling a space between the housing 15 and plate 21.

As shown in FIG. 12, the entire surface of the circuit board 20B on the side of the motor shaft 20C is fixed onto the thick base 40 of the plate 21 in a surface contact state, so that the vibration of the polygon mirror 20A is received by the entire circuit board 20B. Further, since the plate 21 is a hard and heavy member, such as aluminium die cast, the vibration of the circuit board 20B can be received by the entire plate 21 to thereby suppress the vibration. Therefore, it is possible to reduce the vibration and noise caused by rotation of the polygon motor 20.

FIG. 13 is a characteristic graph for explaining the vibration reduction effect of the present invention and shows a noise spectrum obtained when the polygon motor 20 is rotated at 60000 rpm. The horizontal axis represents noise frequency, and vertical axis represents noise level. The solid line in the graph represents characteristics obtained in the light scanning unit according to the present invention (type in which circuit board 20B and plate 21 surface contact each other), the dotted line represents characteristics of the conventional light scanning unit (type in which there is space between circuit board 20B and plate 21).

As can be seen from the characteristic graph, the noise level has been improved by about 4 dB in terms of overall value when the polygon motor 20 is rotated at 60000 rpm. The rotation speed of the motor, which has been about 20000 to 40000 rpm, becomes now higher, up to about 60000 rpm, with the result that noise level becomes higher. Under the circumstances, the present invention contributes to a reduction in noise level. The reduction in the vibration of the polygon motor 20 leads to a reduction in misalignment in light scanning direction to thereby increase deflection capability.

As described above, in the light scanning unit according to the second embodiment of the present invention, the entire surface of the circuit board 20B is fixed onto the plate 21 in a surface contact state, so that the vibration caused by rotation of the polygon mirror 20A is received by the entire plate 21. As a result, vibration and noise can further be reduced.

The present invention is not limited to the above embodiments, and various changes and modifications can be made. For example, although a laser beam is projected from one laser source 31 to the polygon mirror 20A in the above embodiments, the present invention is also applicable to a multi-beam type light scanning unit in which two laser sources are symmetrically disposed with respect to the polygon mirror 20A and laser beams are emitted therefrom in different horizontal directions. Further, the present invention is applicable to a light scanning unit including a polygon mirror 20A constituted by a plurality of polygon mirrors stacked in the vertical direction.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

What is claimed is:

1. A light scanning unit that scans a laser beam emitted from a laser source, comprising:
a motor block including a polygon motor that scans the laser beam from the laser source, a plate that supports the polygon motor, and a cover that is fixed to the plate and covers the polygon motor; and
a housing including a housing portion that can house the motor block, wherein
the housing is made of synthetic resin, and the plate and cover are made of metal.

2. The light scanning unit according to claim 1, wherein
the cover has a radiation fin, and
the radiation fin is extended outside the housing in a state where the motor block is fitted in the housing.

3. The light scanning unit according to claim 1, wherein
the plate has a cylindrical portion into which the base end of the polygon motor is inserted, the base end being inserted into the cylindrical portion for positioning, and
a space is provided between the cylindrical portion and housing so that they do not contact each other in a state where the motor block has been fitted in the housing.

4. The light scanning unit according to claim 3, wherein
the cylindrical portion has a radiation fin at the leading end thereof, and
the radiation fin is extended outside the housing in a state where the motor block is fitted in the housing.

5. The light scanning unit according to claim 1, wherein
a cushioning material that absorbs the vibration generated in the polygon motor is provided between the plate and cover.

6. A light scanning unit that scans a laser beam emitted from a laser source, comprising:
a motor block including a polygon motor that scans the laser beam from the laser source, and a plate that supports the polygon motor; and
a housing including a housing portion that can house the motor block, wherein
the housing is made of synthetic resin, and the plate is made of metal.

7. A light scanning unit that scans a laser beam emitted from a laser source, comprising:
a polygon motor attached to a circuit board and including a polygon mirror that scans a laser beam and a motor shaft, the polygon mirror being disposed on the side of one surface of the circuit board, the motor shaft having a base end protruded toward the side of the other surface of the circuit board; and
a metal plate including a fix hole for receiving insertion of the base end of the motor shaft, the metal plate supporting, in a surface contact state, the entire surface of the circuit board on the side toward which the base end of the motor shaft is protruded when the base end is inserted into the fix hole.

8. The light scanning unit according to claim 7, wherein
the plate has, on one side surface, a base that supports the entire surface of the circuit board on the side toward which the base end of the motor shaft is protruded in a surface contact state when the base end is inserted into the fix hole and has, on the other side surface, a cylindrical portion that covers the outer circumference of the base end that has been inserted into the fix hole.

9. A light scanning unit according to claim 7, comprising:
a motor block constituted by the polygon motor and plate, and
an optical system including a plurality of lenses that guide a laser beam that has been scanned by the polygon motor to a photoconductor, wherein
the motor block and optical system are housed in a housing.

10. A light scanning unit according to claim 9, wherein
a foamed rubber is adhered to the surface of the plate on the side of the housing.

11. A light scanning unit according to claim 9, further comprising:
a metal cover that is attached to the plate so as to cover the motor block that is housed in the housing; and
a roof plate that covers the optical system housed in the housing.
